(19) United States
(12) Patent Application Publication
(10) Pub. No.: US 2025/0370775 A1
(43) Pub. Date: Dec. 4, 2025

(54) INTERFACE GENERATION METHOD, SERVICE CONFIGURATION METHOD, MEDIUM, AND DEVICE

(71) Applicant: Beijing Youzhuju Network Technology Co., Ltd., Beijing (CN)

(72) Inventor: Li JIA, Beijing (CN)

(21) Appl. No.: 19/220,846

(22) Filed: May 28, 2025

(30) Foreign Application Priority Data
May 29, 2024 (CN) 202410685261.5

(51) Int. Cl. G06F 9/451

(52) U.S. Cl. CPC G06F 9/451

(57) ABSTRACT

The present disclosure relates to an interface generation method, a service configuration method, an apparatus, a medium and a device. The generation method includes: acquiring industry description information corresponding to a target industry to be configured, the industry description information includes field information corresponding to configuration of a service in the target industry; generating interactive configuration code of a service configuration interface corresponding to the target industry according to the field information, the interactive configuration code is used for interaction between a front end and a back end of the service configuration interface; and generating the service configuration interface corresponding to the target industry based on the interactive configuration code and an interface template, the service configuration interface is used for entry of information of the service in the target industry.

### CROSS-REFERENCE TO RELATED APPLICATION

This application claims the priority to and benefits of the Chinese Patent Application, No. 202410685261.5, which was filed on May 29, 2024. The aforementioned patent application is hereby incorporated by reference in its entirety.

### TECHNICAL FIELD

The present disclosure relates to an interface generation method, a service configuration method, an apparatus, a medium, and a device.

### BACKGROUND

With the development of computer technology, services in different industries can be browsed and selected through online applications, for example, wedding photography services can be purchased through online applications, and legal consulting services can also be purchased. However, in the service platform, there is a great difference between the configuration information corresponding to the above different services. In the related art, it is usually necessary for the R & D personnel to develop a variety of different service configuration interfaces in advance, so as to adapt to the configuration of information of services of different types, so that a variety of services can be displayed in the service platform.

### SUMMARY

The Summary is provided to introduce concepts in a brief form, which will be described in detail in the Detailed Description below. This Summary is not intended to identify key features or essential features of the claimed technical solution, nor is it intended to be used to limit the scope of the claimed technical solution.

In a first aspect, the present disclosure provides a method for generating a service configuration interface, including:
acquiring industry description information corresponding to a target industry to be configured, the industry description information includes field information corresponding to configuration of a service in the target industry;
generating interactive configuration code of a service configuration interface corresponding to the target industry according to the field information, the interactive configuration code is used for interaction between a front end and a back end of the service configuration interface; and
generating the service configuration interface corresponding to the target industry based on the interactive configuration code and an interface template, the service configuration interface is used for entry of information of the service in the target industry.

In a second aspect, the present disclosure provides a service configuration method, including:
determining a configuration industry to which a target service to be configured belongs;
displaying a service configuration interface corresponding to the configuration industry, the service configuration interface is generated based on the method for generating a service configuration interface according to the first aspect; and
generating configuration information of the target service based on input information in response to an input operation on the service configuration interface.

In a third aspect, the present disclosure provides an apparatus for generating service configuration interface, including:
a first acquisition module, configured to acquire industry description information corresponding to a target industry to be configured, where the industry description information includes field information corresponding to configuration of a service in the target industry;
a first generation module, configured to generate interactive configuration code of a service configuration interface corresponding to the target industry according to the field information, the interactive configuration code is used for interaction between a front end and a back end of the service configuration interface; and
a second generation module, configured to generate the service configuration interface corresponding to the target industry based on the interactive configuration code and an interface template, the service configuration interface is used for entry of information of the service in the target industry.

In a fourth aspect, the present disclosure provides a service configuration apparatus, including:
a second determination module, configured to determine a configuration industry to which a target service to be configured belongs;
a display module, configured to present a service configuration interface corresponding to the configuration industry, the service configuration interface is generated based on the method for generating a service configuration interface according to the first aspect; and
a fourth generation module, configured to generate configuration information of the target service based on input information in response to an input operation on the service configuration interface.

In a fifth aspect, the present disclosure provides a computer readable medium, on which a computer program is stored, the computer program, when executed by a processing apparatus, implements the steps of the method according to the first aspect or the second aspect.

In a sixth aspect, the present disclosure provides an electronic device, including:
a storage apparatus, on which a computer program is stored; and
a processing apparatus, configured to execute the computer program in the storage apparatus to implement the steps of the method according to the first aspect or the second aspect.

In a seventh aspect, the present disclosure provides a computer program product, including a computer program, where the computer program, when executed by a processor, implements the steps of the method according to the first aspect or the second aspect.

Other features and advantages of the present disclosure will be described in detail in the following Detailed Description.

### BRIEF DESCRIPTION OF DRAWINGS

The above and other features, advantages and aspects of the embodiments of the present disclosure will become more apparent with reference to the following specific implementations and in conjunction with the drawings. Throughout the drawings, the same or similar reference signs refer to the same or similar elements. It should be understood that the drawings are schematic and that the components and elements are not necessarily drawn to scale. In the drawings:

FIG. 1 is a flowchart of a method for generating a service configuration interface according to an embodiment of the present disclosure.

FIG. 2 is a preview of a service configuration interface created based on an embodiment of the present disclosure.

FIG. 3 is an interaction flowchart in a process of generating a service configuration interface based on an embodiment of the present disclosure.

FIG. 4 is a flowchart of a service configuration method according to an embodiment of the present disclosure.

FIG. 5 is a block diagram of an apparatus for generating a service configuration interface according to an embodiment of the present disclosure.

FIG. 6 is a block diagram of a service configuration apparatus according to an embodiment of the present disclosure.

FIG. 7 shows a schematic structural diagram of an electronic device suitable for implementing the embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms, and should not be construed as being limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps recited in the method implementations of the present disclosure may be performed in a different order, and/or in parallel. In addition, the method implementations may include additional steps and/or omit to perform the illustrated steps. The scope of the present disclosure is not limited in this respect.

As used herein, the term “include/comprise” and its variations are open-ended inclusions, that is, “include/comprise but not limited to”. The term “based on” is “based, at least in part, on”. The term “one embodiment” means “at least one embodiment”; the term “another embodiment” means “at least one additional embodiment”; and the term “some embodiments” means “at least some embodiments”. Related definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifiers “one” and “a plurality” mentioned in the present disclosure are illustrative and not restrictive, and those skilled in the art should understand that they should be understood as “one or more” unless the context clearly indicates otherwise.

The names of messages or information exchanged between a plurality of apparatuses in the implementations of the present disclosure are only for illustrative purposes, and are not intended to limit the scope of these messages or information.

It should be understood that before using the technical solutions disclosed in the embodiments of the present disclosure, users should be informed of the type, usage scope, usage scenarios, etc. of the personal information involved in the present disclosure through appropriate methods in accordance with relevant laws and regulations, and the authorization of the users should be obtained.

For example, in response to receiving an active request from a user, prompt information is sent to the user to clearly prompt the user that the operation requested to be performed will require the acquisition and use of the user's personal information. Therefore, the user can independently choose whether to provide personal information to software or hardware such as an electronic device, an application, a server or a storage medium that performs the operations of the technical solutions of the present disclosure according to the prompt information.

As an optional but not limiting implementation, the manner of sending prompt information to the user in response to receiving the active request from the user may be, for example, a pop-up window, and the prompt information may be presented in text in the pop-up window. In addition, the pop-up window may also carry a selection control for the user to select “agree” or “disagree” to provide personal information to the electronic device.

It should be understood that the above process of notifying and obtaining user authorization is only illustrative and does not limit the implementations of the present disclosure, and other methods that meet relevant laws and regulations may also be applied to the implementations of the present disclosure.

At the same time, it should be understood that the data involved in the technical solution (including but not limited to the data itself, the acquisition or use of data) should comply with the requirements of corresponding laws, regulations and relevant regulations.

The application scenarios of the solution are described below. The process of selecting services in online applications usually needs to go through the following processes in advance:

Service definition: the service platform can analyze and standardize the definition based on the basic requirements of services in different industries to obtain industry description information, which describes the basic components of a service in the industry, such as fields that need to be configured.

Service configuration: different service providers enter the services they provide (such as photography, vehicle maintenance, etc.) based on the format defined by the industry description information.

Service recommendation: different services are understood through the entered service configuration to realize service recommendation.

Service display: the recommended service is displayed to the user.

After the above process, the user can select the service he needs from the displayed services.

In combination with the above content and the background technology, the information entry in the service configuration process, as a basic part of the service configuration process, has a great impact on the accuracy of subsequent service recommendation. In the related art, when the developer develops the service configuration interface, the first is the requirement analysis and design stage. In this stage, the developer provides requirements for new business entities, so that the requirement analysis and design personnel analyze the requirements and design interfaces and databases. After that, the developer can modify the existing interface definition or add new interfaces and obtain interface documents, modify the database table structure to complete the database change, and modify the code of existing modules to add new code modules for processing business entities, so as to obtain corresponding service configuration interfaces. Since there may be a large number of services in different industries in the service platform, the above solution requires too much manual workload. Based on this, the present disclosure provides the following embodiments.

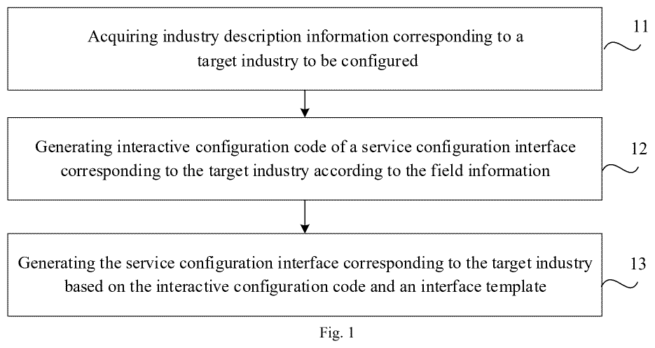

FIG. 1 is a flowchart of a method for generating a service configuration interface according to an embodiment of the present disclosure. As shown in FIG. 1, the method includes:

In step 11, acquiring industry description information corresponding to a target industry to be configured, where the industry description information includes field information corresponding to configuration of a service in the target industry.

When entering services in different industries, the corresponding information usually varies greatly. For example, the services in the legal industry and the services in the photography industry require different attributes to be configured, while the services in the same industry usually require similar attributes to be configured. Based on this, in the present disclosure, a plurality of industries may be classified in advance to obtain different industry types, and then a corresponding service configuration interface may be generated for each industry.

The industry description information may be implemented based on a json structure to describe various fields for service configuration, such as the definition determined in the service definition process described above. Taking the service in the individual portrait-travel photography industry as an example, the industry description information may include the service name, service type, service image, current service price, original service price, shooting area, shooting scene, number of shots, number of retouched pictures, and so on, which can be configured according to the requirements of actual application scenarios.

For example, the industry description information may be expressed as follows:

```
{
  “type”: “object”,
  “properties”: {
    “serviceName”: {
      “type”: “string”,
      “description”: “Service name”
},
    “serviceType”: {
      “type”: “string”,
      “description”: “Service type”
},
...
}
}
```

In step 12, generating interactive configuration code of a service configuration interface corresponding to the target industry according to the field information, where the interactive configuration code is used for interaction between a front end and a back end of the service configuration interface. Exemplarily, the user may configure in a front end of the service configuration interface, such as entering a service name, selecting a service type, etc., and then the data of the user needs to interact with a back end to realize the storage of configuration information. Therefore, in the present disclosure, interactive configuration code for interacting data of each field with the back end may be generated based on the field information. For example, the interactive configuration code may include code for creating or adding, deleting, modifying and querying a database table in a database, API (Application Programming Interface) configuration code, message notification code, and so on.

In step 13, generating the service configuration interface corresponding to the target industry based on the interactive configuration code and an interface template, where the service configuration interface is used for entry of information of the service in the target industry.

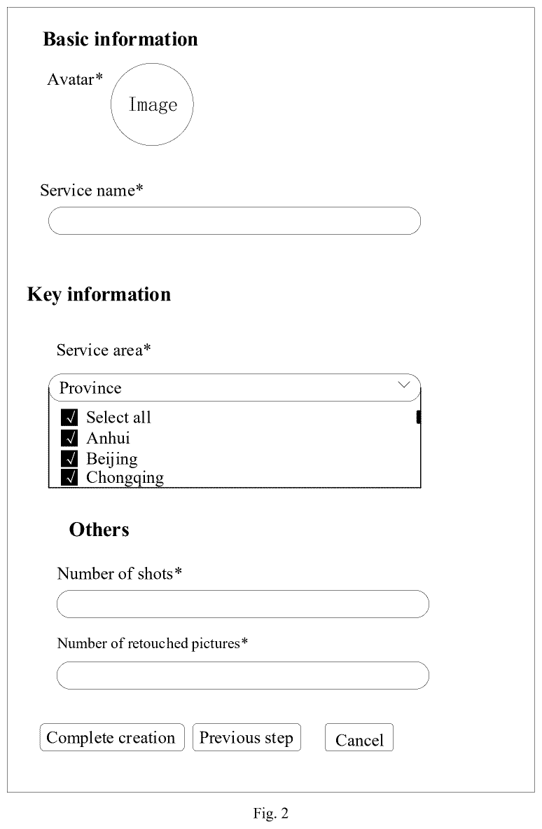

A corresponding interface template may be set in advance for each industry, or a plurality of industries may use the same interface template, and the interface template includes front-end display style information of the service configuration interface, and various fields may be displayed according to the style information, for example, the display name of control 1 is “service name”, and the display type is input box, the display name of control 2 is “service type”, and the display type is drop-down selection box, etc., where the mapping relationship between the control type and the field type may be set in advance, and when displaying, the control type matching with the field type may be directly determined based on the field type for display. FIG. 2 shows a preview of a service configuration interface created based on an embodiment of the present disclosure.

Exemplarily, the interface template may also be a user-defined template, for example, the user may define the display size and color of the control by himself, for example, operations such as hovering prompt may be displayed, then when generating the service configuration interface, the front-end interface generation may be performed based on the user-defined interface template to obtain a service configuration interface that meets the user's requirements, and at the same time, the service configuration interface is associated with its corresponding interactive configuration code. Correspondingly, the user may enter information of various fields of the service through the configuration of various controls of the service configuration interface, and the entered information may interact with the back-end service based on the interactive configuration code to realize the storage and update of the configuration information of the service.

Therefore, through the above technical solutions, the field information corresponding to the configuration of the service in the target industry is obtained based on the industry description information corresponding to the target industry, and then the interactive configuration code of the service configuration interface corresponding to the target industry can be generated based on the field information, and the service configuration interface corresponding to the target industry is further generated in combination with the interface template, where the service configuration interface includes the interactive configuration code, so that the information entered based on the service configuration interface can be stored and called based on the interactive configuration code. Therefore, the automatic generation of the service configuration interfaces in different industries can be realized, the workload of manual analysis and development can be effectively reduced, the labor cost can be reduced, and the application scope of the method can be broadened. The service configuration interface for different industries can be quickly generated, the generation efficiency of the service configuration interface can be improved, and the construction speed of the service information entry system can be increased, so as to provide support for the subsequent entry of configuration information for different services. At the same time, it is convenient for users to accurately enter information for different services, which is convenient for users to operate.

In a possible embodiment, the generating the interactive configuration code of the service configuration interface corresponding to the target industry according to the field information may include:
generating database table code corresponding to the service configuration interface according to the field information, the database table code is used for generating a database table, and the database table includes various fields in the field information, so that data received from the various fields in the service configuration interface can be stored in the database table in a one-to-one correspondence.

The information entered for the service needs to be stored, so the corresponding database table needs to be generated in the database. In this step, the database table code corresponding to the service configuration interface may be automatically generated based on the field information.

Exemplarily, the generating the database table code corresponding to the service configuration interface according to the field information includes:
determining various fields in the field information and a field attribute of each of the fields according to the field information. As in the example of the industry description information shown above, various fields and their attributes may be determined from “properties”, for example, taking the names of various fields in the industry description information as the field names in the database table, and taking their attributes as the attributes of the fields in the database table. For example, the field “serviceName” is determined, and its corresponding type is “string”.

Generating an SQL statement according to the field and the field attribute, where the SQL statement is used for creating a database table in a database and creating a field in the field information in the database table, and the database table code includes the SQL statement.

Correspondingly, the construction of the database table may be performed based on the field and the field attribute, for example, the SQL statement for creating the database table is usually implemented by using a CREATE TABLE command. In order to add a new field (column) to the database table, an ALTER TABLE statement is usually used, followed by an ADD COLUMN command. Then the database table may be created in the database based on the CREATE TABLE, and the SQL statement for adding various fields to the database table is generated through the above statement for adding fields. Then the database table corresponding to the service configuration interface may be automatically generated in the database based on the database table code, so as to subsequently store the entry data received from the service configuration interface.

Exemplarily, the solution of the present disclosure may support and adapt to a variety of database types. For example, before the database table code, the developer may perform pre-configuration based on the database type in the terminal to which the service configuration interface belongs. For example, before the step of generating the interactive configuration code of the service configuration interface corresponding to the target industry according to the field information, the method may further include: determining a type of an interactive module according to a configuration operation in response to receiving the configuration operation on the interactive module, and then generating the interactive configuration code of the service configuration interface corresponding to the target industry according to the field information and the type of the interactive module. For example, the interactive module may be a module that interacts based on the generated interactive configuration code, such as a database system, an API system, or the like. The following takes the database system as an example for description. Different service platforms may have different database types corresponding to their underlying storage, so developers may configure based on the type of the corresponding database for storage. For example, if the configuration operation selects the type of the database as mysql, correspondingly, when the interactive configuration code of the service configuration interface corresponding to the target industry is generated according to the field information and the type of the interactive module, the generated database table code may be code corresponding to the mysql database. If the configuration operation selects the type of the database as oracle, correspondingly, when the interactive configuration code of the service configuration interface corresponding to the target industry is generated according to the field information and the type of the interactive module, the generated database table code may be code corresponding to the oracle database. Therefore, in the process of generating the interactive configuration code, it is possible to support the user to configure the selection of the interactive module personally, thereby further improving the application scope of the method of the present disclosure.

Therefore, the database table code for the service configuration interface can be automatically generated, and then the database table code can be used to interact with the database to automatically generate the corresponding database table in the database, without manual design and creation of the database table, thus improving the efficiency.

After that, database operation code and message configuration code corresponding to the database table are generated according to the database table code.

The database operation code is used to add, modify or query data in the database table, etc. Correspondingly, the generating the database operation code corresponding to each field in the database table according to the database table code may include:
generating data insertion code, data modification code and data query code corresponding to the database table, where the database operation code includes the data insertion code, data modification code and data query code.

The “INSERT” statement is used to add new data to the database table, the “DELETE” statement is used to delete data in the database table, the “Update” statement is used to modify data in the database table, and the “SELECT” statement is used to query data from the database table. Then the data insertion code corresponding to the database table may be generated based on the “INSERT” statement to insert a row of data into the database table, the data modification code is generated based on the “DELETE” and “Update” statements to delete or update data in the database table, and the data query code is generated based on the “SELECT” statement to realize the query of data in the database table.

Therefore, the code for interacting with the data in the database table can be further automatically generated, so that the user can modify the data from the service configuration interface and then synchronously modify the data in the database.

In an actual application scenario, a change of an object, that is, a change of a certain field value of the object in the database table, usually requires a message notification to its downstream service. For example, if the effective date of the service changes, the SMS system may be notified to trigger SMS notification to the corresponding user that the effective date of the service has changed.

Correspondingly, in the embodiment of the present disclosure, the generating the message configuration code corresponding to the database table according to the database table code may include:
determining a message format corresponding to each of the fields, where the message format corresponding to each field may be set in advance, for example, the message format may include message content corresponding to the message and a generation mechanism. For example, for the balance change, the corresponding message content may be “You currently consume XX2 yuan at XX1, and the balance is XX3 yuan”, and the generation mechanism is to determine that the field value corresponding to the balance changes. Whether a message is generated may be determined based on a binlog mechanism in the database. The binlog records the change of the database table structure and the table data, and the message generation and sending can be triggered by monitoring the change of the binlog.

Generating the message configuration code based on the field and the message format, where the message configuration code is used for triggering a message corresponding to the message format after a field value of the field is updated.

As in the above example, for the field of the balance, the code may be generated according to the message content of “You currently consume XX2 yuan at XX1, and the balance is XX3 yuan” in the message format, where XX1, XX2 and XX3 correspond to corresponding fields in the database table, for example, XX1 corresponds to the consumption place field, XX2 corresponds to the consumption value field, and XX3 corresponds to the balance field, then the message configuration code may be generated through the field names or references of the above fields, and at the same time, the monitoring code for the change of the balance field may be added to the message configuration code. Correspondingly, when the change of the field is monitored, the message configuration code may be executed to trigger the corresponding message notification.

Therefore, through the above technical solutions, by generating the message configuration code, the corresponding message notification can be generated in time when the data in the database table changes, so as to ensure the perception of the data change in the database table and improve the interactivity of the generated service configuration interface.

After that, interface configuration code corresponding to each of the fields is generated according to the database operation code corresponding to the database table, where the interactive configuration code includes the database table code, the interface configuration code, the message configuration code and the database operation code.

As mentioned above, the database operation code may provide the capability of adding, deleting, modifying and querying data in the database, and at the same time, the capability needs to be exposed to realize the access of external systems to the data in the database. Correspondingly, in this embodiment, the corresponding interface configuration code may be generated based on the database operation code, so as to realize the operation on the data in the database based on the interface configuration code.

Correspondingly, the generating the interface configuration code corresponding to each of the fields according to the database operation code corresponding to the database table includes:
generating an operation method corresponding to the database table based on the database operation code;
the operation method for performing data insertion on the database table, the operation method for performing data deletion, the operation method for performing data update, and the operation method for performing data query may be generated separately based on the database operation code. The operation method is a function method Function that implements a corresponding function, and the generation of the operation method may be specifically set based on the type of the database or the type of the generated code. For example, if the database is a MySQL database, the corresponding operation may be realized by connecting to the database and executing the corresponding SQL code through the mysql_query function.

Generating interface configuration code corresponding to the database table based on the operation method, where the interface configuration code is used for calling the operation method to operate a field in the database table.

Correspondingly, an API definition, that is, the interface configuration code, may be generated based on the operation method. After that, in a running stage, the interface configuration code may be interacted with an API system to generate a corresponding API, so as to realize the access of the external system to the data. The interface configuration code may also include information such as interface access permission configuration and interface call frequency configuration, which may be set by the developer based on the requirements of actual scenarios.

Exemplarily, the interactive configuration code may also include release code, which is used to determine the display style of the information entered in the service configuration interface. For example, after the user enters information such as the service name, service type, image, etc. in the service configuration interface, a default display style will be generated for the information at the same time, so as to display the information entered by the user based on the display style for further confirmation by the user and submission. The release code may be set for different industries, and if there is no configuration, it may be generated based on the default release code configuration.

Therefore, through the above technical solutions, the interactive configuration code can be automatically generated based on the industry description information, so that the corresponding database table can be automatically generated to accurately store the information entered in the service configuration interface. At the same time, the operations of adding, deleting, modifying, and querying the data in the database can be realized through the database operation code. In addition, the corresponding interface can be generated through the interface configuration code for the external system to access the data, and the corresponding message notification can be triggered by the message configuration code when the data changes. Therefore, the front-end display corresponding to the service configuration interface can be automatically generated, and the back-end interaction logic corresponding to the service configuration interface can be generated at the same time, so that the information entered based on the service configuration interface can be safely and accurately stored and called, providing technical support for the subsequent service understanding and service recommendation.

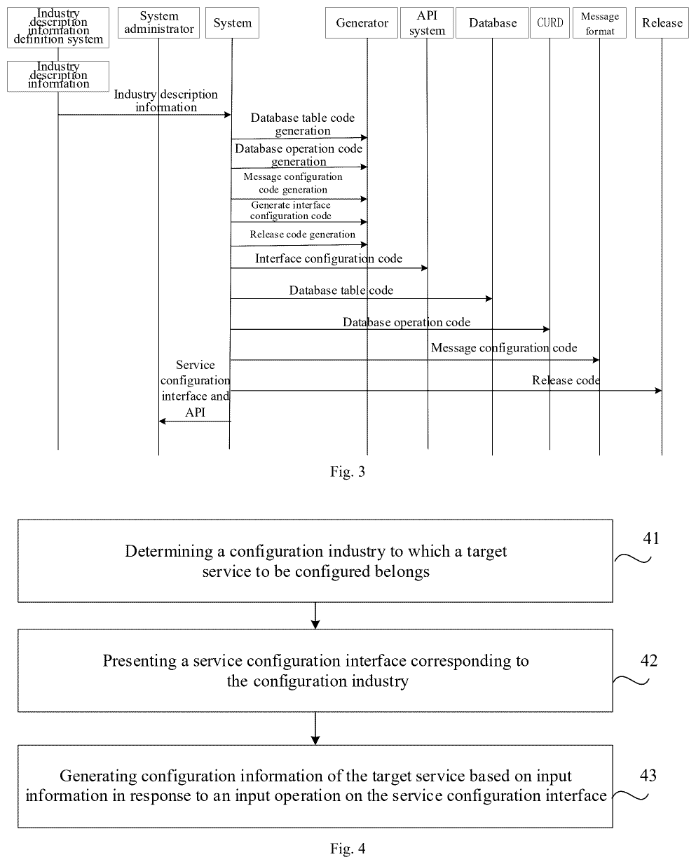

FIG. 3 shows an interaction flowchart in the process of generating the service configuration interface. The industry description information definition system generates industry description information, and the system receives the industry description information, and generates interactive configuration code such as database table code, database operation code, message configuration code, interface configuration code, and release code based on a code generator. After that, the interactive configuration code is used to interact with corresponding systems respectively, for example, interacting with a database system to create a data table, interacting with an API system to obtain a corresponding API, interacting with CURD (adding, deleting, modifying and querying) to operate on data in the data table, triggering message notification based on the message configuration code and the message format, and further determining the display style at the time of release, to finally obtain the corresponding service configuration interface and API. The system administrator can configure the service configuration interface to be effective for application.

In a possible embodiment, the method may further include:
acquiring updated industry description information in response to receiving an update operation on the industry description information; and
generating a new service configuration interface corresponding to the target industry according to the updated industry description information.

If the fields that need to be configured in different industries are updated, the industry description information may be updated directly. For example, if a configuration field is added, the updated industry description information may be acquired in response to the update operation. Further, the new service configuration interface corresponding to the target industry is generated through the above steps 11 to 13 according to the updated industry description information.

Therefore, through the above technical solutions, the update of the service configuration interface can be automatically realized. In the update process, there is no need for the developer to re-develop the service configuration interface. Compared with the operations such as manual change of interface definition, API service, database storage, etc. by the developer in the related art, on the one hand, the efficiency of updating the service configuration interface can be improved, and the cost of manual workload can be saved. On the other hand, it can also effectively avoid the problem that the updated service configuration interface is unavailable due to the omission of updating a certain module or data, and improve the accuracy and availability of the updated service configuration interface.

In a possible embodiment, the method may further include:
receiving an effective configuration rule for the new service configuration interface. Exemplarily, the developer may determine the effective scenario of the new service configuration interface based on the requirements of the actual application scenario, for example, the new service configuration interface may be set to be effective for the test request, or the new service configuration interface may be set to be effective for 30% of the service configuration requests.

In response to the request information in the received service configuration request meeting the effective configuration rule, the new service configuration interface is determined as a response interface corresponding to the service configuration request.

Taking the setting that the new service configuration interface is effective for the test request as an example, whether the service configuration request is a test request is determined based on the request information in the received service configuration request, for example, it is determined whether the login user information in the request information is a test user, and if it is a test user, the service configuration request is a test request, and the new service configuration interface may be determined as the response interface corresponding to the service configuration request, to display the new service configuration interface to the test user, and the test user performs the service configuration based on the new service configuration interface.

Correspondingly, in response to the request information in the received service configuration request does not meeting the effective configuration rule, the currently effective service configuration interface is determined as the response interface corresponding to the service configuration request, such as the service configuration interface generated based on the industry description information before the current update.

Therefore, after the new service configuration interface is generated, the effective configuration rule of the service configuration interface may be set to gradually transition to the new service configuration interface for service configuration, so as to improve the reliability and accuracy of the application of the new service configuration interface and ensure the effective progress of the service information configuration process.

Based on the same inventive concept, the present disclosure further provides a service configuration method. As shown in FIG. 4, the method may include:

In step 41, determining a configuration industry to which a target service to be configured belongs.

The classification of different industries may be set in advance, and the user may select the configuration industry to which the target service to be configured belongs based on the industry classification. The classification may be multi-level classification, such as “life service/photography/comprehensive portrait/individual portrait-travel photography”, or the corresponding configuration industry may be determined by directly searching for travel photography from the classification.

In step 42, displaying a service configuration interface corresponding to the configuration industry, where the service configuration interface is generated based on the method for generating a service configuration interface according to any one of the above, and correspondingly, the service configuration interface corresponding to the configuration industry may be presented for the user to enter service information.

In step 43, generating configuration information of the target service based on input information in response to an input operation on the service configuration interface.

The user may enter information in the service configuration interface. After the user confirms that the entry is completed and submits it, the configuration information of the target service may be generated, and the configuration information may be stored in the database table, and an external system with access permission may access the stored configuration information based on the corresponding API.

Therefore, through the above technical solutions, each industry may be provided with its own independent and matching service configuration interface, so that users can enter services based on corresponding service configuration interfaces, and services in the same industry may use the same service configuration interface to enter information, so as to realize unified management of different services in the same industry, which is convenient for realizing similar service recommendation.

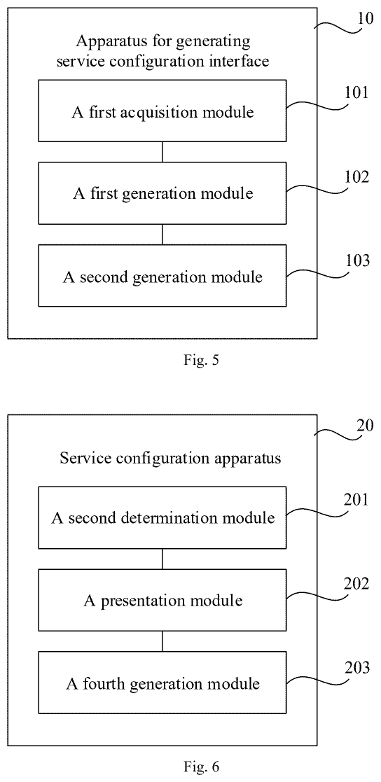

Based on the same inventive concept, the present disclosure further provides a method for generating a service configuration interface. As shown in FIG. 5, the apparatus 10 includes:
a first acquisition module 101, configured to acquire industry description information corresponding to a target industry to be configured, where the industry description information includes field information corresponding to configuration of a service in the target industry;
a first generation module 102, configured to generate interactive configuration code of a service configuration interface corresponding to the target industry according to the field information, where the interactive configuration code is used for interaction between a front end and a back end of the service configuration interface; and
a second generation module 103, configured to generate the service configuration interface corresponding to the target industry based on the interactive configuration code and an interface template, where the service configuration interface is used for entry of information of the service in the target industry.

Optionally, the first generation module includes:
a first generation sub-module, configured to generate database table code corresponding to the service configuration interface according to the field information, where the database table code is used for generating a database table, and the database table includes various fields in the field information;
a second generation sub-module, configured to generate database operation code and message configuration code corresponding to the database table according to the database table code; and
a third generation sub-module, configured to generate interface configuration code corresponding to each of the fields according to the database operation code corresponding to the database table, where the interactive configuration code includes the database table code, the interface configuration code, the message configuration code and the database operation code.

Optionally, the first generation sub-module includes:
a first determination sub-module, configured to determine various fields in the field information and a field attribute of each of the fields according to the field information; and
a fourth generation sub-module, configured to generate an SQL statement according to the field and the field attribute, where the SQL statement is used for creating a database table in a database and creating a field in the field information in the database table, and the database table code includes the SQL statement.

Optionally, the second generation sub-module includes:
a fifth generation sub-module, configured to generate data insertion code, data modification code and data query code corresponding to the database table, where the database operation code includes the data insertion code, data modification code and data query code.

Optionally, the third generation sub-module includes:
a sixth generation sub-module, configured to generate an operation method corresponding to the database table based on the database operation code; and
a seventh generation sub-module, configured to generate interface configuration code corresponding to the database table based on the operation method, where the interface configuration code is used for calling the operation method to operate a field in the database table.

Optionally, the second generation sub-module includes:
a second determination sub-module, configured to determine a message format corresponding to each of the fields; and
an eighth generation sub-module, configured to generate the message configuration code based on the field and the message format, where the message configuration code is used for triggering a message corresponding to the message format after a field value of the field is updated.

Optionally, the apparatus further includes:
a second acquisition module, configured to acquire updated industry description information in response to receiving an update operation on the industry description information; and
a third generation module, configured to generate a new service configuration interface corresponding to the target industry according to the updated industry description information.

Optionally, the apparatus further includes:
a reception module, configured to receive an effective configuration rule for the new service configuration interface; and
a first determination module, configured to determine the new service configuration interface as a response interface corresponding to a service configuration request in response to request information in the received service configuration request meeting the effective configuration rule.

Based on the same inventive concept, the present disclosure further provides a service configuration apparatus. As shown in FIG. 6, the apparatus 20 includes:
a second determination module 201, configured to determine a configuration industry to which a target service to be configured belongs;
a display module 202, configured to present a service configuration interface corresponding to the configuration industry, where the service configuration interface is generated based on the method for generating a service configuration interface according to any one of the above; and
a fourth generation module 203, configured to generate configuration information of the target service based on input information in response to an input operation on the service configuration interface.

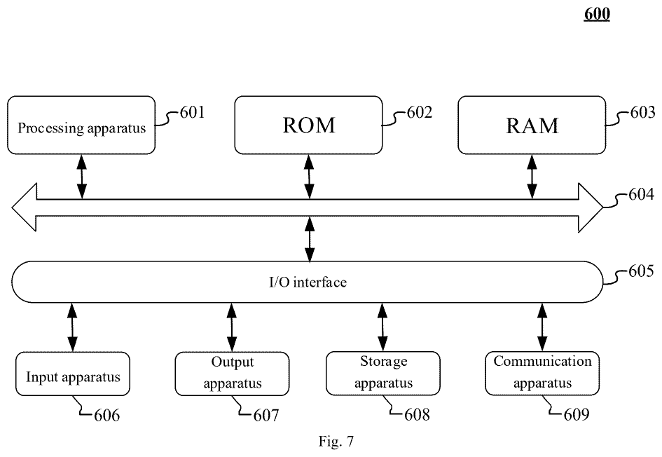

Reference is made to FIG. 7 below, which shows a schematic structural diagram of an electronic device (such as a terminal device or a server) 600 suitable for implementing the embodiments of the present disclosure. The terminal device in the embodiment of the present disclosure may include, but is not limited to, mobile terminals such as a mobile phone, a notebook computer, a digital broadcast receiver, a PDA (personal digital assistant), a PAD (tablet computer), a PMP (portable multimedia player), a vehicle-mounted terminal (such as a vehicle-mounted navigation terminal), etc., and fixed terminals such as a digital TV, a desktop computer, etc. The electronic device shown in FIG. 7 is only an example, and should not bring any limitation to the function and use scope of the embodiments of the present disclosure.

As shown in FIG. 7, the electronic device 600 may include a processing apparatus (such as a central processing unit, a graphics processor, etc.) 601, which may perform various appropriate actions and processing according to a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602 and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 7 shows the electronic device 600 with various apparatuses, it should be understood that not all of the illustrated apparatuses are required to be implemented or provided. More or fewer apparatuses may be implemented or provided alternatively.

In particular, according to an embodiment of the present disclosure, the processes described above with reference to the flowcharts may be implemented as computer software programs. For example, an embodiment of the present disclosure includes a computer program product, which includes a computer program carried on a non-transitory computer-readable medium, and the computer program includes program codes for executing the method shown in the flowcharts. In such an embodiment, the computer program may be downloaded and installed from the network through the communication apparatus 609, or installed from the storage apparatus 608, or installed from the ROM 602. When the computer program is executed by the processing apparatus 601, the above functions defined in the method of the embodiment of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in conjunction with an instruction execution system, apparatus or device. In the present disclosure, the computer-readable signal medium may include a data signal that propagates in a baseband or as a part of a carrier, and carries computer-readable program codes. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit the program for use by or in conjunction with the instruction execution system, apparatus or device. The program codes contained in the computer-readable medium may be transmitted by any suitable medium, including but not limited to: electric wires, optical cables, RF (radio frequency), etc., or any suitable combination thereof.

In some implementations, clients and servers may communicate using any currently known or future-developed network protocol, such as HTTP (HyperText Transfer Protocol), and may be interconnected with digital data communications (for example, communication networks) in any form or medium. Examples of communication networks include local area networks (“LAN”), wide area networks (“WAN”), the Internet, and end-to-end networks (for example, ad hoc end-to-end networks), as well as any currently known or future-developed network.

The above computer-readable medium may be included in the above electronic device, or may exist alone without being assembled into the electronic device.

The above computer-readable medium carries one or more programs, and when the one or more programs are executed by the electronic device, the electronic device is caused to: acquire industry description information corresponding to a target industry to be configured, where the industry description information includes field information corresponding to configuration of a service in the target industry; generate interactive configuration code of a service configuration interface corresponding to the target industry according to the field information, where the interactive configuration code is used for interaction between a front end and a back end of the service configuration interface; and generate the service configuration interface corresponding to the target industry based on the interactive configuration code and an interface template, where the service configuration interface is used for entry of information of the service in the target industry.

Alternatively, the above computer-readable medium carries one or more programs, and when the one or more programs are executed by the electronic device, the electronic device is caused to: determine a configuration industry to which a target service to be configured belongs; present a service configuration interface corresponding to the configuration industry, where the service configuration interface is generated based on the method for generating a service configuration interface according to any one of the above; and generate configuration information of the target service based on input information in response to an input operation on the service configuration interface.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as “C” programming language or similar programming languages. The program codes may be executed entirely on the user's computer, partly on the user's computer, as a stand-alone software package, partly on the user's computer and partly on a remote computer, or entirely on the remote computer or server. In the scenario involving the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowchart or block diagram may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that each block of the block diagrams and/or flowcharts, and combinations of blocks in the block diagrams and/or flowcharts, may be implemented by special purpose hardware-based systems that perform the specified functions or operations, or combinations of special purpose hardware and computer instructions.

The modules involved in the embodiments described in the present disclosure may be implemented in software or hardware. The name of the module does not constitute a limitation of the module itself under certain circumstances. For example, the first acquisition module may also be described as “a module for acquiring industry description information corresponding to a target industry to be configured”.

The functions described herein above may be performed, at least partially, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides a method for generating a service configuration interface, the method includes:
acquiring industry description information corresponding to a target industry to be configured, where the industry description information includes field information corresponding to configuration of a service in the target industry;
generating interactive configuration code of a service configuration interface corresponding to the target industry according to the field information, where the interactive configuration code is used for interaction between a front end and a back end of the service configuration interface; and
generating the service configuration interface corresponding to the target industry based on the interactive configuration code and an interface template, where the service configuration interface is used for entry of information of the service in the target industry.

According to one or more embodiments of the present disclosure, Example 2 provides the method of Example 1, where the generating the interactive configuration code of the service configuration interface corresponding to the target industry according to the field information includes:
generating database table code corresponding to the service configuration interface according to the field information, where the database table code is used for generating a database table, and the database table includes various fields in the field information;
generating database operation code and message configuration code corresponding to the database table according to the database table code; and
generating interface configuration code corresponding to each of the fields according to the database operation code corresponding to the database table, where the interactive configuration code includes the database table code, the interface configuration code, the message configuration code and the database operation code.

According to one or more embodiments of the present disclosure, Example 3 provides the method of Example 2, where the generating the database table code corresponding to the service configuration interface according to the field information includes:
determining various fields in the field information and a field attribute of each of the fields according to the field information; and
generating an SQL statement according to the field and the field attribute, where the SQL statement is used for creating a database table in a database and creating a field in the field information in the database table, and the database table code includes the SQL statement.

According to one or more embodiments of the present disclosure, Example 4 provides the method of Example 2, where the generating the database operation code corresponding to the database table according to the database table code includes:
generating data insertion code, data modification code and data query code corresponding to the database table, where the database operation code includes the data insertion code, data modification code and data query code.

According to one or more embodiments of the present disclosure, Example 5 provides the method of Example 4, where the generating the interface configuration code corresponding to each of the fields according to the database operation code corresponding to the database table includes:
generating an operation method corresponding to the database table based on the database operation code; and
generating interface configuration code corresponding to the database table based on the operation method, where the interface configuration code is used for calling the operation method to operate a field in the database table.

According to one or more embodiments of the present disclosure, Example 6 provides the method of Example 2, where the generating the message configuration code corresponding to the database table according to the database table code includes:
determining a message format corresponding to each of the fields; and
generating the message configuration code based on the field and the message format, where the message configuration code is used for triggering a message corresponding to the message format after a field value of the field is updated.

According to one or more embodiments of the present disclosure, Example 7 provides the method of Example 1, where the method further includes:
acquiring updated industry description information in response to receiving an update operation on the industry description information; and
generating a new service configuration interface corresponding to the target industry according to the updated industry description information.

According to one or more embodiments of the present disclosure, Example 8 provides the method of Example 7, where the method further includes:
receiving an effective configuration rule for the new service configuration interface; and
determining the new service configuration interface as a response interface corresponding to a service configuration request in response to request information in the received service configuration request meeting the effective configuration rule.

According to one or more embodiments of the present disclosure, Example 9 provides a service configuration method, including:
determining a configuration industry to which a target service to be configured belongs;
displaying a service configuration interface corresponding to the configuration industry, where the service configuration interface is generated based on the method for generating a service configuration interface according to any one of Examples 1 to 8; and
generating configuration information of the target service based on input information in response to an input operation on the service configuration interface.

According to one or more embodiments of the present disclosure, Example 10 provides an apparatus for generating a apparatus, including:
a first acquisition module, configured to acquire industry description information corresponding to a target industry to be configured, where the industry description information includes field information corresponding to configuration of a service in the target industry;
a first generation module, configured to generate interactive configuration code of a service configuration interface corresponding to the target industry according to the field information, where the interactive configuration code is used for interaction between a front end and a back end of the service configuration interface; and
a second generation module, configured to generate the service configuration interface corresponding to the target industry based on the interactive configuration code and an interface template, where the service configuration interface is used for entry of information of the service in the target industry.

According to one or more embodiments of the present disclosure, Example 11 provides a service configuration apparatus, including:
a second determination module, configured to determine a configuration industry to which a target service to be configured belongs;
a display module, configured to present a service configuration interface corresponding to the configuration industry, where the service configuration interface is generated based on the method for generating a service configuration interface according to any one of Examples 1 to 8; and
a fourth generation module, configured to generate configuration information of the target service based on input information in response to an input operation on the service configuration interface.

According to one or more embodiments of the present disclosure, Example 12 provides a computer readable medium, on which a computer program is stored, where the computer program, when executed by a processing apparatus, implements the steps of the method according to any one of Examples 1 to 9.

According to one or more embodiments of the present disclosure, Example 13 provides an electronic device, including:
a storage apparatus, on which a computer program is stored; and
a processing apparatus, configured to execute the computer program in the storage apparatus to implement the steps of the method according to any one of Examples 1 to 9.

According to one or more embodiments of the present disclosure, Example 14 provides a computer program product, including a computer program, where the computer program, when executed by a processor, implements the steps of the method according to any one of Examples 1 to 9.

The above description is only the preferred embodiments of the present disclosure and the illustration of the applied technical principles. Those skilled in the art should understand that the disclosure scope involved in the present disclosure is not limited to the technical solutions formed by the specific combination of the above technical features, but also covers other technical solutions formed by any combination of the above technical features or their equivalent features without departing from the above disclosure concept. For example, the technical solutions formed by replacing the above features with the technical features with similar functions disclosed in the present disclosure (but not limited to).

In addition, although operations are depicted in a particular order, this should not be understood as requiring these operations to be performed in a specific order or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only exemplary forms of implementing the claims. Regarding the apparatus in the above embodiments, the specific manner in which each module performs operations has been described in detail in the embodiments related to the method, and will not be described in detail here.

1. A method for generating a service configuration interface, comprising:
acquiring industry description information corresponding to a target industry to be configured, wherein the industry description information comprises field information corresponding to configuration of a service in the target industry;
generating interactive configuration code of a service configuration interface corresponding to the target industry according to the field information, wherein the interactive configuration code is used for interaction between a front end and a back end of the service configuration interface; and
generating the service configuration interface corresponding to the target industry based on the interactive configuration code and an interface template, wherein the service configuration interface is used for entry of information of the service in the target industry.

2. The method according to claim 1, wherein the generating interactive configuration code of a service configuration interface corresponding to the target industry according to the field information comprises:
generating database table code corresponding to the service configuration interface according to the field information, wherein the database table code is used for generating a database table, and the database table comprises fields in the field information;
generating database operation code and message configuration code corresponding to the database table according to the database table code; and
generating interface configuration code corresponding to each of the fields according to the database operation code corresponding to the database table, wherein the interactive configuration code comprises the database table code, the interface configuration code, the message configuration code and the database operation code.

3. The method according to claim 2, wherein the generating database table code corresponding to the service configuration interface according to the field information comprises:
determining the fields in the field information and a field attribute of each of the fields according to the field information; and
generating an SQL statement according to the fields and the field attribute, wherein the SQL statement is used for creating the database table in a database and creating a field in the field information in the database table, and the database table code comprises the SQL statement.

4. The method according to claim 2, wherein the generating database operation code corresponding to the database table according to the database table code comprises:
generating data insertion code, data modification code and data query code corresponding to the database table, wherein the database operation code comprises the data insertion code, the data modification code and the data query code.

5. The method according to claim 4, wherein the generating interface configuration code corresponding to each of the fields according to the database operation code corresponding to the database table comprises:
generating an operation method corresponding to the database table based on the database operation code; and
generating the interface configuration code corresponding to the database table based on the operation method, wherein the interface configuration code is used for calling the operation method to operate a field in the database table.

6. The method according to claim 2, wherein the generating message configuration code corresponding to the database table according to the database table code comprises:
determining a message format corresponding to each of the fields; and
generating the message configuration code based on the field and the message format, wherein the message configuration code is used for triggering a message corresponding to the message format after a field value of the field is updated.

7. The method according to claim 1, further comprising:
acquiring updated industry description information in response to receiving an update operation on the industry description information; and
generating a new service configuration interface corresponding to the target industry according to the updated industry description information.

8. The method according to claim 7, further comprising:
receiving an effective configuration rule for the new service configuration interface; and
determining the new service configuration interface as a response interface corresponding to a service configuration request in response to request information in a received service configuration request meeting the effective configuration rule.

9. A service configuration method, comprising:
determining a configuration industry to which a target service to be configured belongs;
displaying a service configuration interface corresponding to the configuration industry, wherein the service configuration interface is generated based on the method for generating a service configuration interface according to claim 1; and
generating configuration information of the target service based on input information in response to an input operation on the service configuration interface.

10. A non-transient computer-readable medium, storing a computer program thereon, the computer program, when executed by a processing apparatus, causing the processing apparatus to implement step of a method for generating a service configuration interface, wherein the method comprises:
acquiring industry description information corresponding to a target industry to be configured, wherein the industry description information comprises field information corresponding to configuration of a service in the target industry;
generating interactive configuration code of a service configuration interface corresponding to the target industry according to the field information, wherein the interactive configuration code is used for interaction between a front end and a back end of the service configuration interface; and
generating the service configuration interface corresponding to the target industry based on the interactive configuration code and an interface template, wherein the service configuration interface is used for entry of information of the service in the target industry.

11. A non-transient computer-readable medium, storing a computer program thereon, the computer program, when executed by a processing apparatus, causing the processing apparatus to implement step of a method for generating a service configuration interface, wherein the method comprises:
determining a configuration industry to which a target service to be configured belongs;
displaying a service configuration interface corresponding to the configuration industry, wherein the service configuration interface is generated based on the method for generating a service configuration interface according to claim 1; and
generating configuration information of the target service based on input information in response to an input operation on the service configuration interface.

12. An electronic device, comprising:
a storage apparatus, configured to store a computer program; and
a processing apparatus, configured to execute the computer program in the storage apparatus to implement the steps of a method for generating a service configuration interface, which comprises:
acquiring industry description information corresponding to a target industry to be configured, wherein the industry description information comprises field information corresponding to configuration of a service in the target industry;
generating interactive configuration code of a service configuration interface corresponding to the target industry according to the field information, wherein the interactive configuration code is used for interaction between a front end and a back end of the service configuration interface; and
generating the service configuration interface corresponding to the target industry based on the interactive configuration code and an interface template, wherein the service configuration interface is used for entry of information of the service in the target industry.

13. The electronic device according to claim 12, wherein the generating interactive configuration code of a service configuration interface corresponding to the target industry according to the field information comprises:
generating database table code corresponding to the service configuration interface according to the field information, wherein the database table code is used for generating a database table, and the database table comprises fields in the field information;
generating database operation code and message configuration code corresponding to the database table according to the database table code; and
generating interface configuration code corresponding to each of the fields according to the database operation code corresponding to the database table, wherein the interactive configuration code comprises the database table code, the interface configuration code, the message configuration code and the database operation code.

14. The electronic device according to claim 13, wherein the generating database table code corresponding to the service configuration interface according to the field information comprises:
determining the fields in the field information and a field attribute of each of the fields according to the field information; and
generating an SQL statement according to the fields and the field attribute, wherein the SQL statement is used for creating the database table in a database and creating a field in the field information in the database table, and the database table code comprises the SQL statement.

15. The electronic device according to claim 13, wherein the generating database operation code corresponding to the database table according to the database table code comprises:
generating data insertion code, data modification code and data query code corresponding to the database table, wherein the database operation code comprises the data insertion code, the data modification code and the data query code.

16. The electronic device according to claim 15, wherein the generating interface configuration code corresponding to each of the fields according to the database operation code corresponding to the database table comprises:
generating an operation method corresponding to the database table based on the database operation code; and
generating the interface configuration code corresponding to the database table based on the operation method, wherein the interface configuration code is used for calling the operation method to operate a field in the database table.

17. The electronic device according to claim 13, wherein the generating message configuration code corresponding to the database table according to the database table code comprises:
determining a message format corresponding to each of the fields; and
generating the message configuration code based on the field and the message format, wherein the message configuration code is used for triggering a message corresponding to the message format after a field value of the field is updated.

18. The electronic device according to claim 12, wherein the method further comprises:
acquiring updated industry description information in response to receiving an update operation on the industry description information; and
generating a new service configuration interface corresponding to the target industry according to the updated industry description information.

19. The electronic device according to claim 18, wherein the method further comprises:
receiving an effective configuration rule for the new service configuration interface; and
determining the new service configuration interface as a response interface corresponding to a service configuration request in response to request information in a received service configuration request meeting the effective configuration rule.

20. An electronic device, comprising:
a storage apparatus, on which a computer program is stored; and
a processing apparatus, configured to execute the computer program in the storage apparatus to implement the steps of a service configuration method, which comprises:
determining a configuration industry to which a target service to be configured belongs;
displaying a service configuration interface corresponding to the configuration industry, wherein the service configuration interface is generated based on the method for generating a service configuration interface according to claim 1; and
generating configuration information of the target service based on input information in response to an input operation on the service configuration interface.
